(19) United States
(12) Patent Application Publication
(10) Pub. No.: US 2005/0055436 A1
(43) Pub. Date: Mar. 10, 2005

(54) Resource load measuring method, network control apparatus, communication node and storage medium

(76) Inventors: Hitoshi Yamada, Kawasaki (JP); Akiko Okamura, Kawasaki (JP); Akira Chugo, Kawasaki (JP); Jianping Pan, Sunnyvale, CA (US)

Correspondence Address: KATTEN MUCHIN ZAVIS ROSENMAN, 575 MADISON AVENUE, NEW YORK, NY, 10022-2585, US

(21) Appl. No.: 10/657,747

(22) Filed: Sep. 8, 2003

(51) Int. Cl. G06F 15/173

(52) U.S. Cl. 709/224

(57) ABSTRACT

A resource load measuring method measures load information of resources within a network, by measuring the load information of the resources at measuring intervals and storing measured load information in a storage section, predicting load information of the resources according to a prediction algorithm and storing predicted load information in the storage section, and adjusting the measuring intervals based on the measured load information and the predicted load information stored in the storage section.

### BACKGROUND OF THE INVENTION

1. Field of the Invention

The present invention generally relates to resource load measuring methods, network control apparatuses, communication nodes and storage media, and more particularly to a resource load measuring method for measuring loads of resources in a network environment, a network control apparatus for performing a network management based on measured loads of resources, a communication node for measuring a load thereof by itself, and a computer-readable storage medium which stores a computer program for causing a computer to function as the network control apparatus or the communication node.

2. Description of the Related Art

In a network environment, main functions of a network control apparatus include monitoring and managing communication nodes within a working network. The communication nodes include routers, switches and servers. The managing functions include managing a network structure, managing faults generated in the communication nodes, and managing load information of resources within the network. A system which monitors and manages the communication nodes within the network is often referred to as the Network Management System (NMS).

Other functions of the network control apparatus include dynamically controlling the network depending on the loads of the resources. For example, a network load balancing function distributes and balances the load within the network so as to avoid congestion, and a server load balancing function distributes and balances the load on the servers by sorting traffic of requests with respect to the servers.

In order to monitor and control the network, it is necessary to measure the load information of the resources. The load information may include the bandwidth of a link between two communication nodes, the amount of traffic, the activity ratio of a CPU within the communication node, the amount of memory space used in the communication node, and the like. The network load balancing function regards a link with a high utilization as a congestion, and carries out a control by moving a portion of the traffic to a detour route having more available bandwidth. The server load balancing function carries out a control to sort the traffic of the requests to the server having a CPU with a low activity ratio.

Conventionally, the load information of the resources is usually collected by the network control apparatus at predetermined measuring intervals which are defined in advance by the, operator, by using a protocol such as the Simple Network Management Protocol (SNMP) and an interface such as the Command Line Interface (CLI). In other words, the measuring intervals are fixed.

On the other hand, a first type of load measurement has been proposed, which automatically shortens the measuring intervals when the measured load information exceeds a threshold value, so as to improve the monitoring accuracy. A Japanese Laid-Open Patent Application No.2000-49940 proposes a traffic measuring apparatus which employs a technique similar to this first type of load measurement. However, in this proposed traffic measuring apparatus, a switching system notifies the load information to the traffic measuring apparatus when the threshold value is exceeded.

In addition, a second type of load measurement has been proposed in a Japanese Laid-Open Patent Application No.7-152706. According to this second type of load measurement, a communication node measures and notifies the load information to the network control apparatus, and the measuring and notifying intervals are dynamically shortened when the load information exceeds a threshold value, so as to reduce the load of the communication node itself.

Furthermore, a third type of load measurement has been proposed in a Japanese Laid-Open Patent Application No.2002-140313. According to this third type of load measurement, the measured load information of a plurality of communication nodes are analyzed so as to predict the load in response to a request.

In order to effectively manage and stably control the network by the network control apparatus, it is desirable that the load measurement is carried out frequently so as to improve the accuracy of the measurement. However, when the measuring frequency is increased, the processing load on the network control apparatus which carries out the load measurement and/or the processing load on the communication node which is the target of the load measurement increase, and moreover, signals used for the load measurement use up a large portion of the bandwidth of the network, to thereby increase the overhead of the measurement (hereinafter simply referred to as a measurement overhead). Therefore, if the measuring intervals are constant, there was a problem in that it is difficult to find optimum measuring intervals which take into consideration a tradeoff between the accuracy of the measurement and the measurement overhead.

The accuracy of the measurement and the measurement overhead may be balanced to a certain extent by dynamically controlling the measuring intervals depending on a relationship between the measured load information and the threshold value. However, there is a limit in suitably controlling the measuring intervals based solely on whether or not the measured load information exceeds the threshold value.

For example, the measured load information may deviate greatly but not exceed the threshold value, but in such a case, although desirable to improve the accuracy of the measurement, the prior art does not shorten the measuring intervals since the threshold value is not exceeded.

Further, the measured load information may be approximately constant and not exceed the threshold value, but in such a case, although desirable to reduce the measurement overhead, the prior art does not lengthen the measuring intervals because the threshold value is not exceeded.

Moreover, when the load information is simply predicted, the measurement overhead can be reduced, but it is difficult to obtain accurate load information which closely approximates the actual load information. For this reason, it is difficult to effectively manage and stably control the network based solely on the predicted load information.

### SUMMARY OF THE INVENTION

Accordingly, it is a general object of the present invention to provide a novel and useful resource load measuring method, network control apparatus, communication node and computer-readable storage medium, in which the problems described above are eliminated.

Another and more specific object of the present invention is to provide a resource load measuring method, a network control apparatus, a communication node and a computer-readable storage medium, which effectively manage and stably control a network while maintaining a high accuracy for measurement of load information of resources, and simultaneously enable reduced measurement overhead.

Still another object of the present invention is to provide a resource load measuring method for measuring load information of resources within a network, comprising measuring the load information of the resources at measuring intervals' and storing measured load information in a storage section; predicting load information of the resources according to a prediction algorithm and storing predicted load information in the storage section; and adjusting the measuring intervals based on the measured load information and the predicted load information stored in the storage section. According to the resource load measuring method of the present invention, it is possible to effectively manage and stably control a network while maintaining a high accuracy for measurement of load information of resources, and simultaneously enable reduced measurement overhead.

A further object of the present invention is to provide a network control apparatus coupled within a network having resources and controlling the network, comprising a storage section; a measuring section to measure load information of the resources at measuring intervals and to store measured load information in the storage section; a predicting section to predict load information of the resources according to a prediction algorithm and to store predicted load information in the storage section; and an adjusting section to adjust the measuring intervals based on the measured load information and the predicted load information stored in the storage section. According to the network control apparatus of the present invention, it is possible to effectively manage and stably control a network while maintaining a high accuracy for measurement of load information of resources, and simultaneously enable reduced measurement overhead.

Another object of the present invention is to provide a communication node coupled within a network having a network control apparatus, comprising a plurality of resources; a storage section; a measuring section to measure load information of the resources at measuring intervals and to store measured load information in the storage section; a predicting section to predict load information of the resources according to a prediction algorithm and to store predicted load information in the storage section; and an adjusting section to adjust the measuring intervals based on the measured load information and the predicted load information stored in the storage section, in response to an instruction from the network control apparatus. According to the communication node of the present invention, it is possible to effectively manage and stably control a network while maintaining a high accuracy for measurement of load information of resources, and simultaneously enable reduced measurement overhead.

Still another object of the present invention is to provide a computer-readable storage medium which stores a computer program for causing a computer to measure load information of resources within a network, the computer program comprising a procedure to cause the computer to measure the load information of the resources at measuring intervals and to store measured load information in a storage section; a procedure to cause the computer to predict load information of the resources according to a prediction algorithm and to store predicted load information in the storage section; and a procedure to cause the computer to adjust the measuring intervals based on the measured load information and the predicted load information stored in the storage section. According to the computer-readable storage medium of the present invention, it is possible to effectively manage and stably control a network while maintaining a high accuracy for measurement of load information of resources, and simultaneously enable reduced measurement overhead.

Other objects and further features of the present invention will be apparent from the following detailed description when read in conjunction with the accompanying drawings.

### BRIEF DESCRIPTION OF THE DRAWINGS

FIG. 1 is a diagram showing a network environment to which the present invention is applied;

FIG. 2 is a functional block diagram showing a first embodiment of a network control apparatus according to the present invention;

FIG. 3 is a flow chart for explaining an operation of a resource measuring section;

FIG. 4 is a flow chart for explaining an operation of a resource predicting section;

FIG. 5 is a flow chart for explaining an operation of a measuring interval controller;

FIG. 6 is a diagram showing a data structure within a data base of resource load information;

FIG. 7 is a flow chart for explaining an operation of a network control information computing section;

FIG. 8 is a flow chart for explaining an operation of a network equipment controller;

FIG. 9 is a diagram showing the network for explaining a first measuring interval control;

FIG. 10 is a diagram showing the network for explaining a second measuring interval control;

FIG. 11 is a diagram showing the network for explaining a third measuring interval control;

FIG. 12 is a flow chart for explaining an operation of a modification of the first embodiment of the network control apparatus;

FIG. 13 is a functional block diagram showing a second embodiment of the network control apparatus according to the present invention;

FIG. 14 is a functional block diagram showing a first embodiment of a communication node according to the present invention;

FIG. 15 is a flow chart for explaining an operation of a resource load information receiver;

FIG. 16 is a flow chart for explaining an operation of a network control information computing section;

FIG. 17 is a flow chart for explaining an operation of a measuring interval controller;

FIG. 18 is a flow chart for explaining an operation of a communication controller;

FIG. 19 is a flow chart for explaining a node process controller; and

FIG. 20 is a system block diagram showing a structure of a computer which is usable as the network control apparatus and the communication node.

### DESCRIPTION OF THE PREFERRED EMBODIMENTS

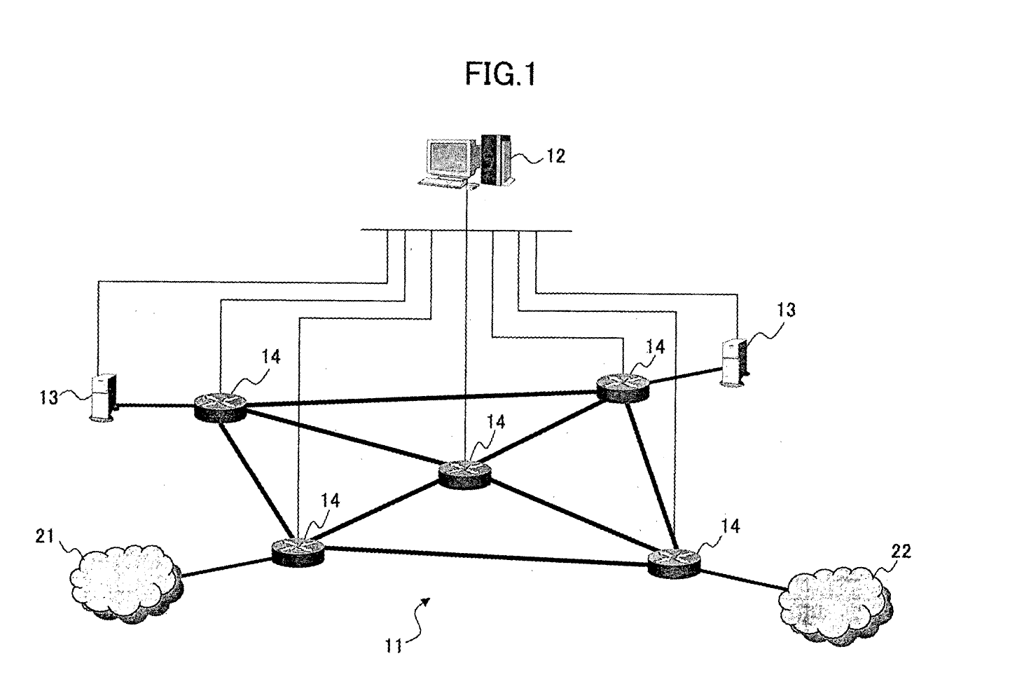

FIG. 1 is a diagram showing a network environment to which the present invention is applied. A network (or network system) 11 shown in FIG. 1 includes a network control apparatus 12, servers 13, and routers (or switches) 14. The network 11 is connected to sub-networks (or networks) 21 and 22. Each of the servers 13 and routers 14 forms a communication node. Further, the network control apparatus 12 may also be regarded as a communication node.

The network control apparatus 12 may be formed by a general purpose computer or the like. Main functions of the network control apparatus 12 include monitoring and managing the communication nodes within the network 11. The monitoring functions include measuring the load of the communication nodes and obtaining load information of the communication nodes. The managing functions include managing the network structure of the network 11, managing faults generated in the communication nodes, and managing the load information of resources within the network 11. In this embodiment, the communication nodes connected within the network 11 or, parts of the communication nodes, form the resources within the network 11.

Other functions of the network control apparatus 12 include dynamically controlling the network 11 depending on the loads of the resources. For example, a network load balancing function distributes and balances the load within the network 11 so as to avoid congestion, and a server load balancing function distributes and balances the load on the servers 13 by sorting traffic of requests with respect to the servers 13.

Each of the servers 13 has known server functions, and may be formed by a general purpose computer. Similarly, each of the routers 14 has known router functions for switching routes for communication. The network 11 may be formed by a cable network, an optical network, a wireless network, or any combination of such networks. Each of the sub-networks 21 and 22 may formed by a cable network, an optical network, a wireless network, or any combination of such networks. Of course, the network 11 may be isolated, in which case the sub-networks 21 and 22 are omitted or, the network 11 may be connected to more than two sub-networks (or networks).

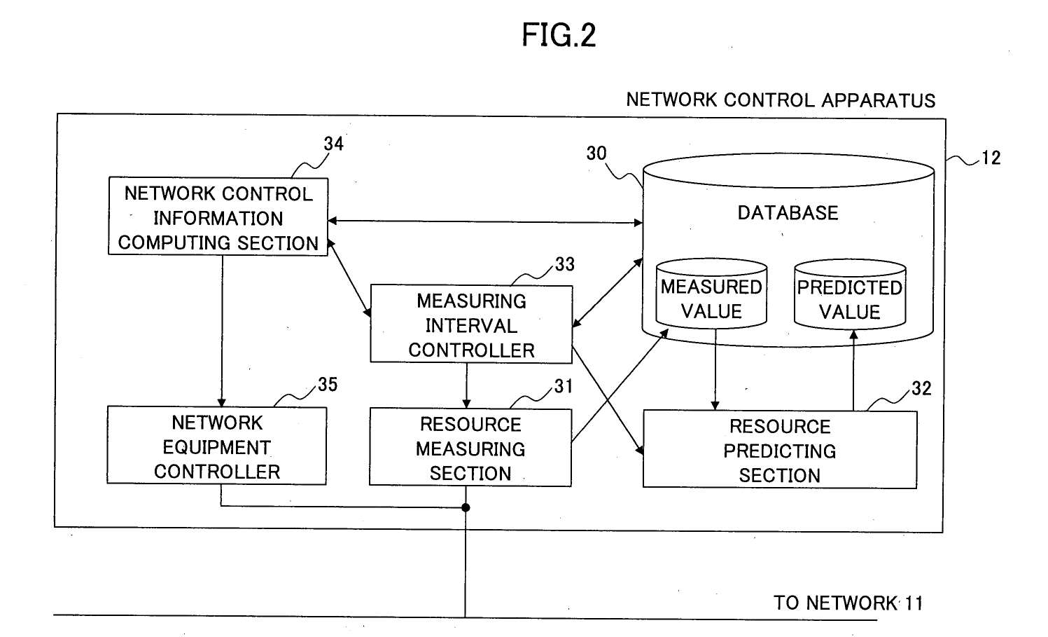

FIG. 2 is a functional block diagram showing a first embodiment of a network control apparatus according to the present invention. This first embodiment of the network control apparatus employs a first embodiment of a resource load measuring method according to the present invention. The network control apparatus 12 shown in FIG. 2 includes a database 30, a resource measuring section 31, a resource predicting section 32, a measuring interval controller 33, a network control information computing section 34, and a network equipment controller 35.

The database 30 stores the load information of the resources within the network 11, and a measuring interval with which the load information of the resources is to be measured. As will be described later, the load information stored in the database 30 includes measured load information and predicted load information.

The resource measuring section 31 is connected to the network 11, and measures the load information of the resources from the communication nodes within in the network 11, using an interface such as the Simple Network Management Protocol (SNMP) and an interface such as the Command Line Interface (CLI), in response to a resource measure instruction from the measuring interval controller 33. The resource measuring section 31 stores the measured load information (or measured value) in the database 30.

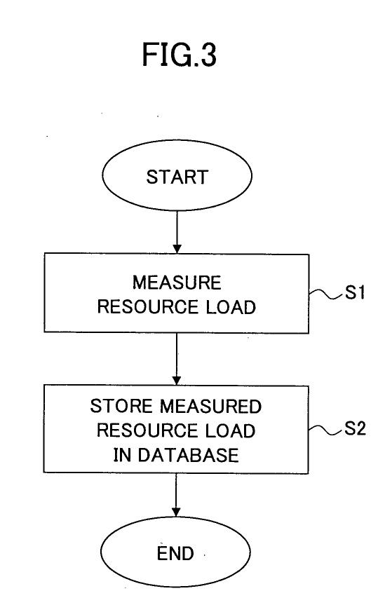

FIG. 3 is a flow chart for explaining an operation of the resource measuring section 31. The operation shown in FIG. 3 starts in response to the resource measure instruction received from the measuring interval controller 33. A step S1 measures the load information of a selected resource. For example, the SNMP is used to obtain Management Information Base (MIB) as the load information by a known means. In addition, the selected resource may be determined depending on a predetermined polling sequence or the like. A step S2 stores the measured load information in the database 30, and the process ends.

The load information may be any information defined by the standard MIB of the SNMP. For example, the load information may be any one or combination of the bandwidth of each interface (corresponding to a link) of the communication node (router 14), a total-number of bytes transmitted via each interface of the communication node (router 14), a number of packets discarded at each interface of the communication node (router 14), an activity ratio of a CPU within the communication node (server 13), an amount of memory space used in the communication node (server 13), a number of connections of the communication node (server 13), and the like. The total number of bytes transmitted via each interface of the communication node may be used to obtain the utilization of each link.

The resource predicting section 32 refers to time-varying information of the measured load information stored in the database 30, and predicts load information which will be obtained for the selected resources when the load information is measured the next time, in response to a resource predict instruction from the measuring interval controller 33. The resource predicting section 32 stores the predicted load information (or predicted value) in the database 30. The method of prediction will be described later.

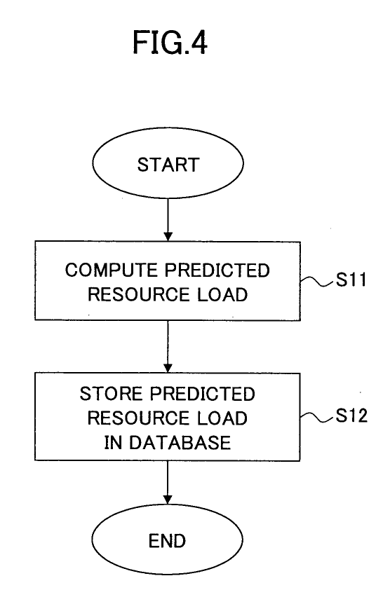

FIG. 4 is a flow chart for explaining an operation of the resource predicting section 32. The operation shown in FIG. 4 starts in response to the resource predict instruction received from the measuring interval controller 33. A step S11 computes the predicted load information for the selected resource using a suitable prediction algorithm such as the Exponentially Weighted Moving Average (EWMA). A step S12 stores the predicted load information in the database 30, and the process ends.

When the EWMA is used for the prediction method, an nth predicted value pₙ can be obtained from pₙ=mₙ₋1+w×eₙ−1, where eₙ−1=mₙ₋1−pₙ−1 is an error between an (n−1)th measured value and an (n−1)th predicted value, and w denotes a weighting parameter which indicates the degree of weight placed on the immediately preceding measured value when making the prediction. Of course, other suitable prediction methods may be employed, such as the Least Square Method (LSM). The LSM computes the predicted value with an even higher accuracy based on time-sequential data of past measured values. In this case, however, it is necessary to store the time-sequential data of the measured values in the database 30.

The measuring interval controller 33 adjusts the next measuring interval based on the measured load information, the predicted load information and the present measuring interval stored in the database 30, in response to an adjust instruction from the network control information computing section 34. The next measuring interval which is adjusted by the measuring interval controller 33 is stored in the database 30. The measuring interval controller 33 also controls the resource measuring section 31 so as to measure the load information of the resources at the adjusted measuring interval.

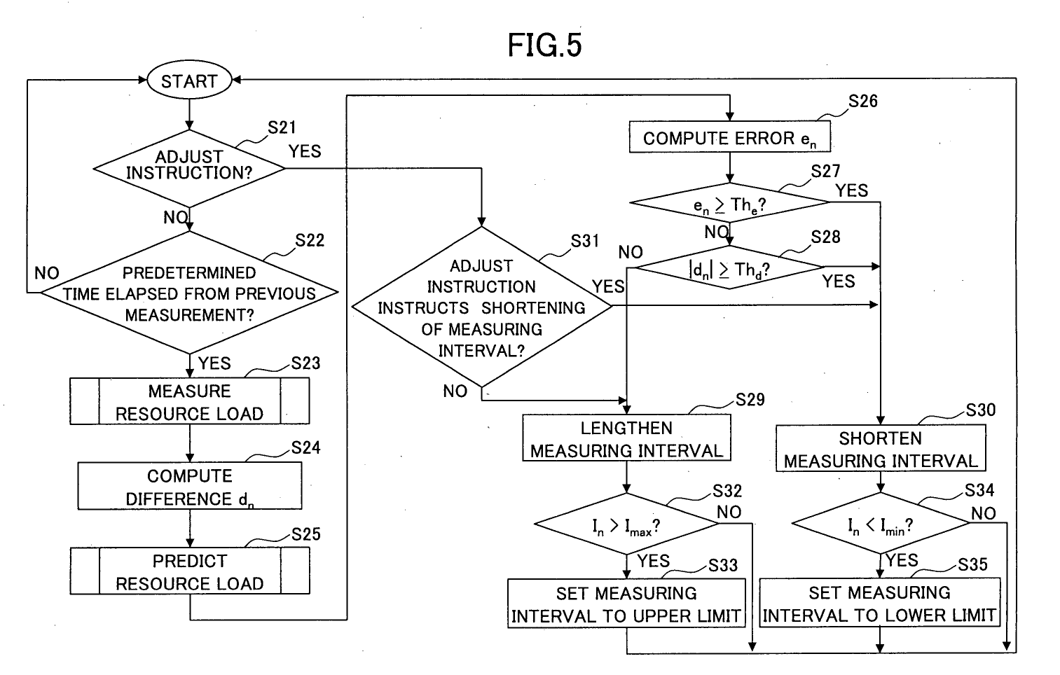

FIG. 5 is a flow chart for explaining an operation of the measuring interval controller 33. For the sake of convenience, FIG. 5 shows the operation of the measuring interval controller 33 for a case where the measuring interval with respect to the selected resource is adjusted.

In FIG. 5, a step S21 decides whether or not the adjust instruction is received from the network control information computing section 34. If the decision result in the step S21 is NO, a step S22 decides whether or not a predetermined time which is greater than or equal to the measuring interval has elapsed from the previous measurement. If the resource measuring section 31 makes the nth measurement at a time tₙ, a measuring interval Iₙ of the nth measurement can be described by Iₙ=tₙ−tₙ₋₁. The process returns to the step S21 if the decision result in the step S22 is NO.

On the other hand, if a time greater than or equal to the present measuring interval Iₙ elapses from the previous measuring time tₙ₋₁ and the decision result in the step S22 is YES, a step S23 measures the load information of the selected resource by instructing the resource measuring section 31 by issuing the resource measure instruction. A step S24 computes a difference dₙ(=mₙ−mₙ−1) between the present (nth measurement) measured load information (measured value) mₙ and the previous measured load information (measured value) mₙ−1, and stores this difference dₙ in the database 30.

A step S25 predicts the load information (predicted value) of the selected resource by instructing the resource predicting section 32 by issuing the resource predict information, and a step S26 computes the error between the measured load information (measured value) and the predicted load information (predicted value). As described above, the predicted value pₙ is obtained from Pₙ=mₙ₋1+w×eₙ−1, where the error eₙ₋₁ between the (n−1)th measured value and the (n−1)th predicted value is described by eₙ−1=mₙ₋1−pₙ−1. Hence, the step S25 computes and stores the predicted value pₙ in the database 30, and the step S26 computes and stores the error eₙ(=mₙ−pₙ) in the database 30.

A step S27 decides whether or not an absolute value of the error eₙ is greater than or equal to a threshold value Thₑ. If the decision result of the step S27 is NO, a step S28 decides whether or not an absolute value of the difference dₙ is greater than or equal to a threshold value Th_{d}.

If the decision result in the step S21 is YES, a step S31 decides whether or not the adjust instruction from the network control information computing section 34 instructs shortening the measuring interval. If the decision result in one of the steps S27, S28 and 31 is YES, the process advances to a step S30. On the other hand, if the decision result in the step S28 or S31 is NO, the process advances to a step S29. The step S29 starts a process of lengthening the measuring interval, and the step S30 starts a process of shortening the measuring interval. Hence, the measuring interval is shortened if the relationship |eₙ|≧Thₑ or |dₙ|≧Th_{d} stands, and the measuring interval is otherwise lengthened.

The step S29 sets the measuring interval Iₙ to I=α_{f}×Iₙ₋₁ based on a constant α_{f} satisfying α_{f}>1. Alternatively, the measuring interval Iₙ is set to Iₙ=Iₙ₋₁+αᵢ based on a positive constant ai. Then, a step S32 decides whether or not the measuring interval Iₙ is longer than an upper limit value Iₘₐₓ. If the decision result in the step S32 is YES, a step S33 sets the measuring interval Iₙ to the upper limit value Iₘₐₓ. In other words, if Iₙ>Iₘₐₓ, Iₙ is set to Iₙ=Iₘₐₓ.

The step S30 sets the measuring interval Iₙ to Iₙ=β_{f}×Iₙ₋₁ based on a constant β_{f} satisfying 0<β_{f}<1. Alternatively, the measuring interval Iₙ is set to Iₙ=I₋₁−βᵢ based on a positive constant βᵢ. Then, a step S34 decides whether or not the measuring interval Iₙ is shorter than a lower limit value Iₘᵢₙ. If the decision result in the step S34 is YES, a step S35 sets the measuring interval Iₙ to the lower limit value Iₘᵢₙ. In other words, if Iₙ<Iₘᵢₙ, In is set to Iₙ=Iₘᵢₙ.

If the decision result in the step S32 or S34 is NO, the process returns to the step S21. Furthermore, the process returns to the step S21 after the step S33 or S35.

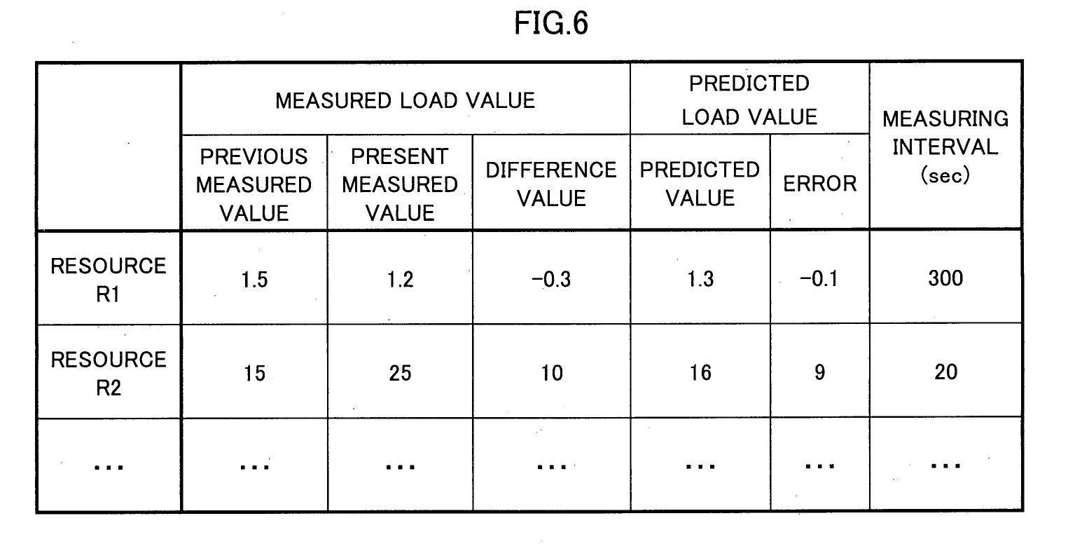

FIG. 6 is a diagram showing a data structure within the data base 30 of the resource load information. As shown in FIG. 6, a measured value information of the load (measured load value information in arbitrary units), a predicted value information of the load (predicted load value information in arbitrary units), and a measuring interval (sec) is stored in the database 30 for each of the resources R1, R2, . . . . The measured load value information includes a previous measured value, a present measured value, and a difference value between the present and previous measured values. The predicted load value information includes a predicted value, and an error between the present measured value and the predicted value.

The network control information computing section 34 refers to the load information and the like stored in the database 30, and computes various control information (parameters) for use in suitably controlling the network load balancing and the server load balancing. The network control information computing section 34 notifies the computed control information to the network equipment controller 35. In addition, based on the computed control information, the network control information computing section 34 sends the adjust instruction to the measuring interval controller 33 so as to adjust the measuring interval of the selected resource which is the target of control.

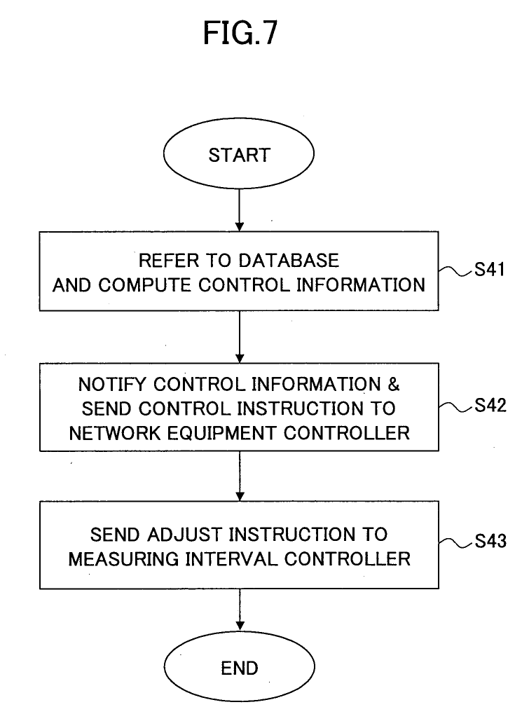

FIG. 7 is a flow chart for explaining an operation of the network control information computing section 34. The operation shown in FIG. 7 starts at an arbitrary timing which may be responsive to the selection of the resource, that is, when a time for measuring or desirably measuring the load information comes.

In FIG. 7, a step S41 refers to the load information and the like stored in the database 30, and computes the control information (parameters) for use in suitably controlling the network load balancing and the server load balancing. The control information may be computed based on the measured load information or the predicted load information. A step S42 notifies the computed control information to the network equipment controller 35, and sends a control instruction to the network equipment controller 35 to carry out a control with respect to the network 11 (equipments within the network 11) based on the computed control information. Based on the computed control information, a step S43 sends the adjust instruction to the measuring interval controller 33 so as to adjust the measuring interval of the selected resource which is the target of control, and the process ends. The selected resource may be the resource which is predicted to show a change in the load which requires measurement such that the shortening of the measuring interval is desired.

The network equipment controller 35 controls the equipments within the network 11 based on the control information received from the network control information computing section 34, in response to the control instruction received from the network control information computing section 34.

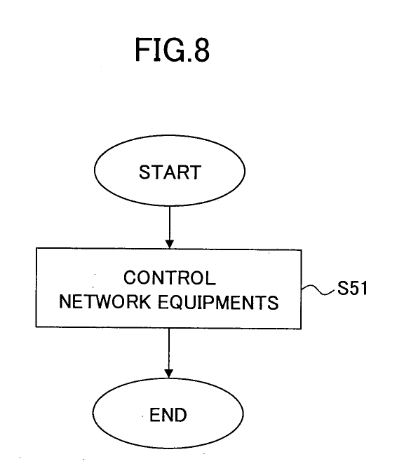

FIG. 8 is a flow chart for explaining an operation of the network equipment controller 35. The operation shown in FIG. 8 is started in response to the control instruction from the network control information computing section 34. A step 51 controls the equipments within the network 11 based on the control information received from the network control information computing section 34, and the process ends.

Next, a description will be given of first, second and third measuring interval controls which dynamically control the measuring interval in accordance with this embodiment. For the sake of convenience, it is assumed to be the network load balancing is performed by the network control. In the case of the network load balancing, the load (utilization) of each link within the network 11 is constantly monitored, and it is regarded that a congestion occurred in the link if the load reaches a predetermined value. The network control apparatus 12 sets a route having a large amount of available bandwidth as a detour route with respect to the traffic passing through the congestion link, and avoids the congestion by moving a portion of the traffic to the detour route.

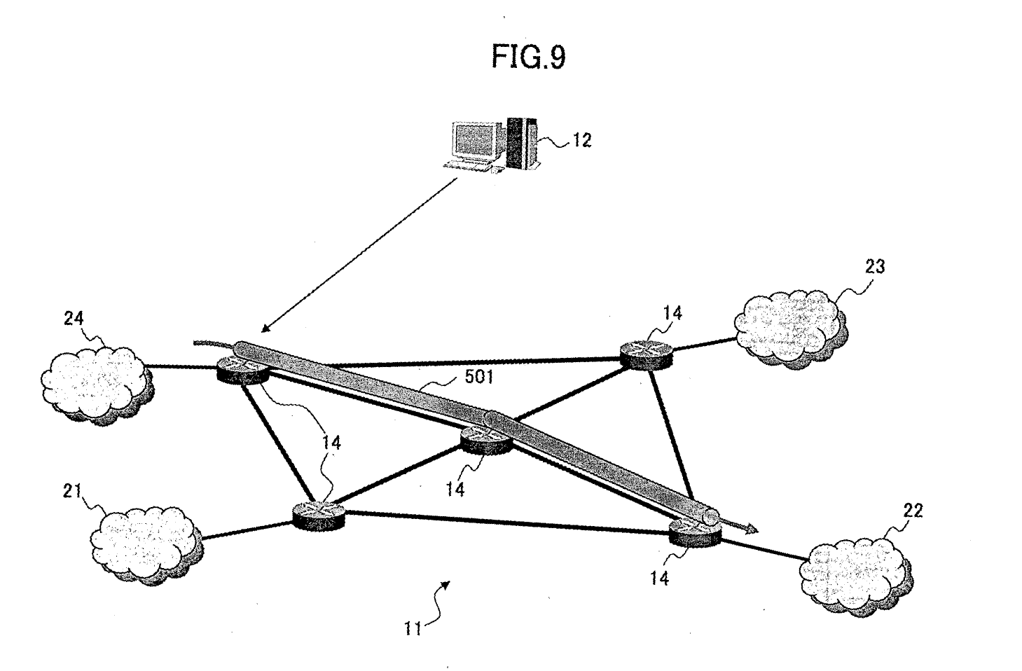

FIG. 9 is a diagram showing the network for explaining the first measuring interval control. In FIG. 9, those parts which are the same as those corresponding parts in FIG. 1 are designated by the same reference numerals, and a description thereof will be omitted. In FIG. 9, two more sub-networks (or networks) 23 and 24 are connected to the network 11.

In FIG. 9, it is assumed for the sake of convenience that the network control apparatus 12 newly sets a path 501 within the network 11 to flow the traffic. If necessary, the network control information computing section 34 computes routes for the path 501, and sends a path set-instruction to the network equipment controller 35 so as to set the path 501. When the traffic starts to flow through the set path 501, an increase in the load of the links in the path 501 can be predicted. Hence, in order to improve the measuring accuracy of the loads of the links, the network control information computing section 34 sends the adjust instruction to the measuring interval controller 33 to adjust and shorten the measuring interval.

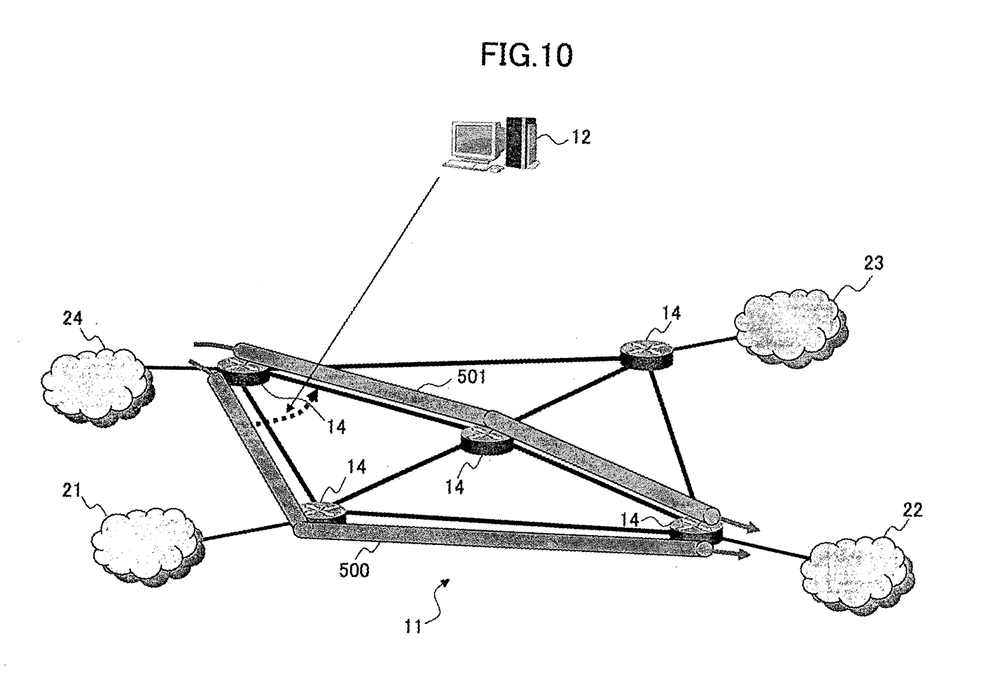

FIG. 10 is a diagram showing the network for explaining the second measuring interval control. In FIG. 10, those parts which are the same as those corresponding parts in FIG. 1 are designated by the same reference numerals, and a description thereof will be omitted. In FIG. 10, two more sub-networks (or networks) 23 and 24 are connected to the network 11.

In FIG. 10, it is assumed for the sake of convenience that the network control apparatus 12 changes (switches) a path 500 within the network 11 for flowing the traffic to the path 501. When the path is changed, a decrease in the load of the links in the original path 500 can be predicted, while an increase in the load of the links in the new path 501 can be predicted. Accordingly, in order to improve the measuring accuracy of the loads of the links, the network control information computing section 34 sends the adjust instruction to the measuring interval-controller 33 to adjust and shorten the measuring interval.

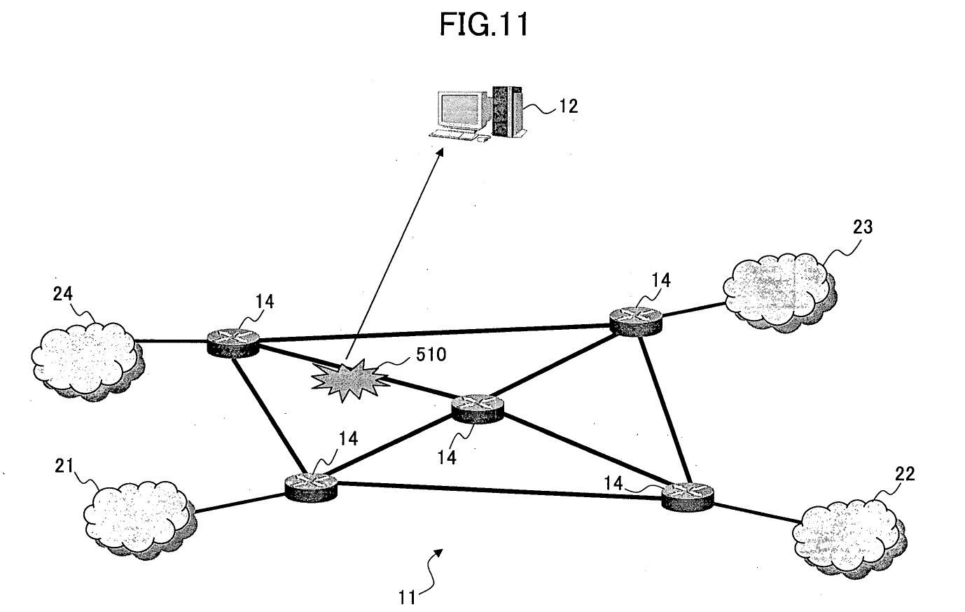

FIG. 11 is a diagram showing the network for explaining the third measuring interval control. In FIG. 11, those parts which are the same as those corresponding parts in FIG. 1 are designated by the same reference numerals, and a description thereof will be omitted. In FIG. 11, two more sub-networks (or networks) 23 and 24 are connected to the network 11.

In FIG. 11, it is assumed for the sake of convenience that the network control apparatus 12 changes (switches) monitored a large change in the load of a certain link 510 within the network 11. In this case, the resource measuring section 31 measures the load of the link 510, and stores the measured load value in the database 30. Thus, in order to improve the measuring accuracy of the loads of the links, the network control information computing section 34 sends the adjust instruction to the measuring interval controller 33, so that the measuring interval controller 33 refers to the measured load value of the link 510 stored in the database 30 which greatly changed, so as to adjust and shorten the measuring interval. By shortening the measuring interval for the link having the load which greatly changed, it is possible to improve the measuring accuracy and to realize a stable network control without delaying detection of the congestion.

In the embodiment described above, the operation of the measuring interval controller 33, shown in FIG. 5 is carried out for each selected resource. In other words, the adjusting interval is adjusted independently for each resource within the network 11. However, if short adjusting intervals are set with respect to a large number of resources, the load of the resource measuring section 31 becomes high when operation of the network control apparatus 12 is considered as a whole.

Accordingly, in order to avoid the load of the resource measuring section 31 from becoming too high and considerably increasing the load of the network control apparatus 12 as a whole, the network control apparatus 12 may carry out a process of adjusting the measuring interval by taking into consideration the load of the network control apparatus 12 as a whole. Hence, in a modification of this embodiment, the measuring interval controller 33 periodically adjusts the measuring interval, for example, depending on the load of the network control apparatus 12 as a whole.

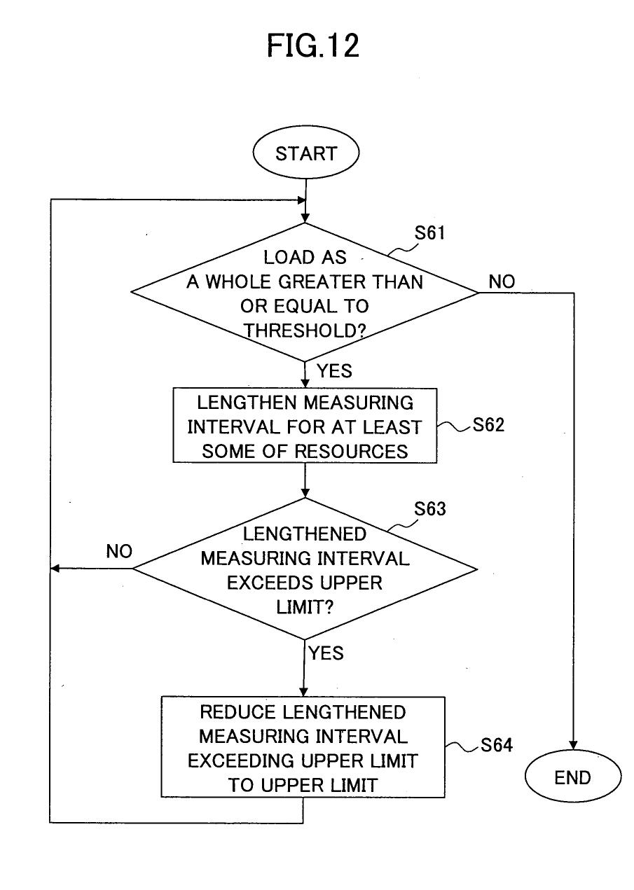

FIG. 12 is a flow chart for explaining an operation of this modification of the first embodiment of the network control apparatus. The operation shown in FIG. 12 is carried out by the measuring interval controller 33 shown in FIG. 2.

In FIG. 12, a step S61 decides whether or not the load of the network control apparatus 12 as a whole for measuring the load information of the resources within the network 11 is greater than or equal to a threshold value, and the process ends if the decision result in the step S61 is NO. For example, the load of the network control apparatus 12 as a whole may be the load of the resource measuring section 31 or, the load of the CPU forming the network control apparatus 12 or, the number of times the network control apparatus 12 measures the load of the resources within the network 11 per unit time. It is possible to use the measuring interval with respect to each of the resources to compute the number of times the network control apparatus 12 measures the load of the resources within the network 11 per unit time, such as per minute.

On the other hand, if the decision result in the step S61 is YES, a step S62 sends the adjust instruction to the resource measuring section 31 to lengthen the measuring interval with respect to at least some of the resources. For example, the adjusting interval may be lengthened by adding or multiplying a constant to the measuring interval of each of the resources which are the measuring targets or, with respect to one or more resources having the shortest measuring interval or, with respect to one or more resources having a measuring interval smaller than or equal to a predetermined value or, with respect to predetermined resources which are determined in advance.

Of course, the measuring interval is lengthened so as not to exceed the upper limit of the measuring interval. Hence, a step S63 decides whether or not the lengthened measuring interval or intervals exceed the upper limit of the measuring interval. The process returns to the step S61 if the decision result in the step S63 is NO. On the other hand, if the decision result in the step S63 is YES, a step S64 reduces each lengthened measuring interval which exceeds the upper limit of the measuring interval, to the upper limit, and the process returns to the step S61.

Therefore, this modification of the first embodiment can prevent the load of the resource measuring process from becoming too large, by suitably adjusting the measuring interval depending on the load of the network control apparatus 12 as a whole.

In the embodiment described above, the measuring interval is adjusted by the network control apparatus 12. However, it is possible to self-adjust the measuring interval in each communication node, as will be described hereunder. In other words, each communication node measures the load of the resource thereof, and notifies the measured load information to the network control apparatus at the self-adjusted measuring interval (or notifying interval). In this case, the network control apparatus carries out the network control based on'the load information received from the communication node.

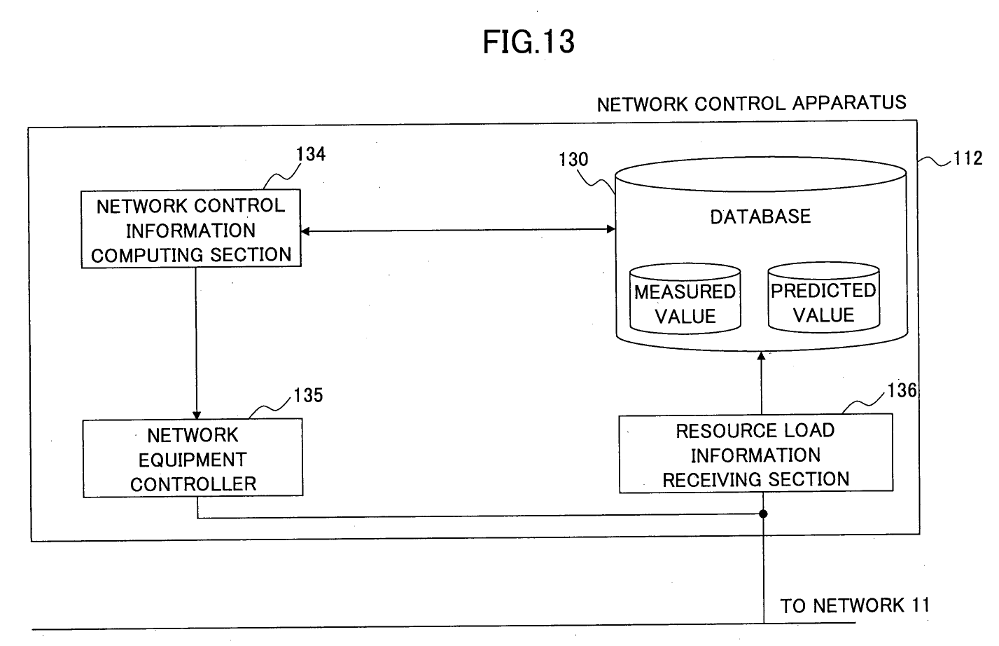

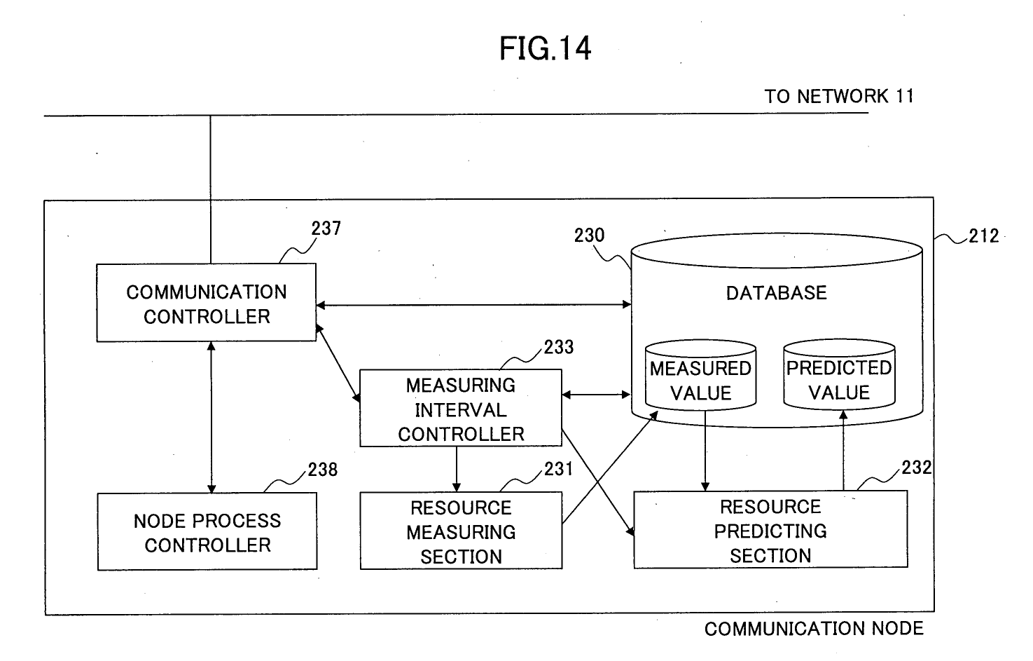

FIG. 13 is a functional block diagram showing a second embodiment of the network control apparatus according to the present invention. In addition, FIG. 14 is a functional block diagram showing a first embodiment of a communication node according to the present invention. This second embodiment of the network control apparatus and this first embodiment of the communication node respectively employ a second embodiment of the resource load measuring method according to the present invention. It is assumed for the sake of convenience, that the second embodiment of the network control apparatus and the first embodiment of the communication node are applicable to the network 11 shown in FIG. 1.

As shown in FIG. 13, a network control apparatus 112 includes a database 130 for storing the load information, a network control information computing section 134, a network equipment controller 135, and a resource load information receiving section 136.

On the other hand, a communication node 212 may be a server or a router, for example. The communication node 212 includes a database 230, a resource predicting section 232, a resource measuring section 231, a measuring interval controller 233, a communication controller 237, and a node process controller 238.

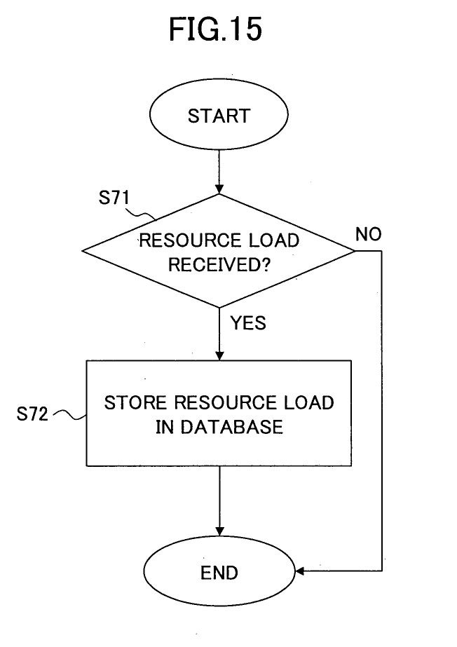

FIG. 15 is a flow chart for explaining an operation of the resource load information receiver 136 of the network control apparatus 112 shown in FIG. 13. As shown in FIG. 15, a step S71 decides whether or not resource load information is received from a communication node, such as the communication node 212 shown in FIG. 14. If the decision result in the step S71 is YES, a step S72 stores the received resource load information in the database 130. If the decision result in the step S71 is NO or, after the step S72, the process ends.

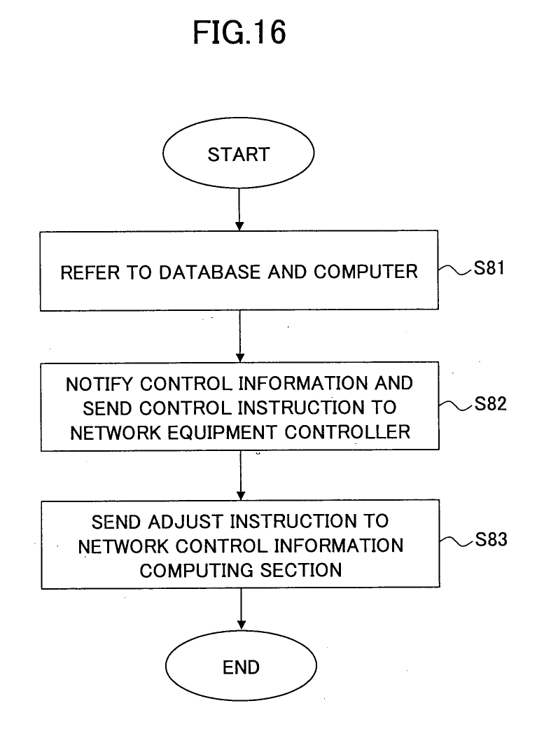

FIG. 16 is a flow chart for explaining an operation of the network control information computing section 134 of the network control apparatus 112 shown in FIG. 13. As shown in FIG. 16, a step S81 refers to the resource load information stored in the database 130, and computes the control information (parameters) for use in suitably carrying out the network control such as controlling the network load balancing and the server load balancing. The control information may be computed based on the measured load information or the predicted load information. A step S82 notifies the computed control information to the network equipment controller 135, and sends a control instruction to the network equipment controller 135 to carry out a control with respect to the network 11 (equipments within the network 11) based on the computed control information. Based on the computed control information, a step S83 sends an adjust instruction to the network control information computing section 134 so as to adjust the measuring interval of the selected resource which is the target of control, and the process ends. The selected resource may be the resource which is predicted to show a change in the load which requires measurement such that the shortening of the measuring interval is desired.

In the communication node 212 shown in FIG. 14, the resource measuring section 231 and the resource predicting section 232 operate similarly to the resource measuring section 31 and the resource predicting section 32 of the network control apparatus 12 shown in FIG. 2, and a description thereof will be omitted. However, in the case of the resource measuring section 231, it is unnecessary to use the SNMP or the like since the measurement is made within the target resource, that is, the communication node 212 to which the resource measuring section 231 belongs, and the resource load information can be acquired directly. The database 230 need only store the resource load information related to the communication node 212 to which the database 230 belongs.

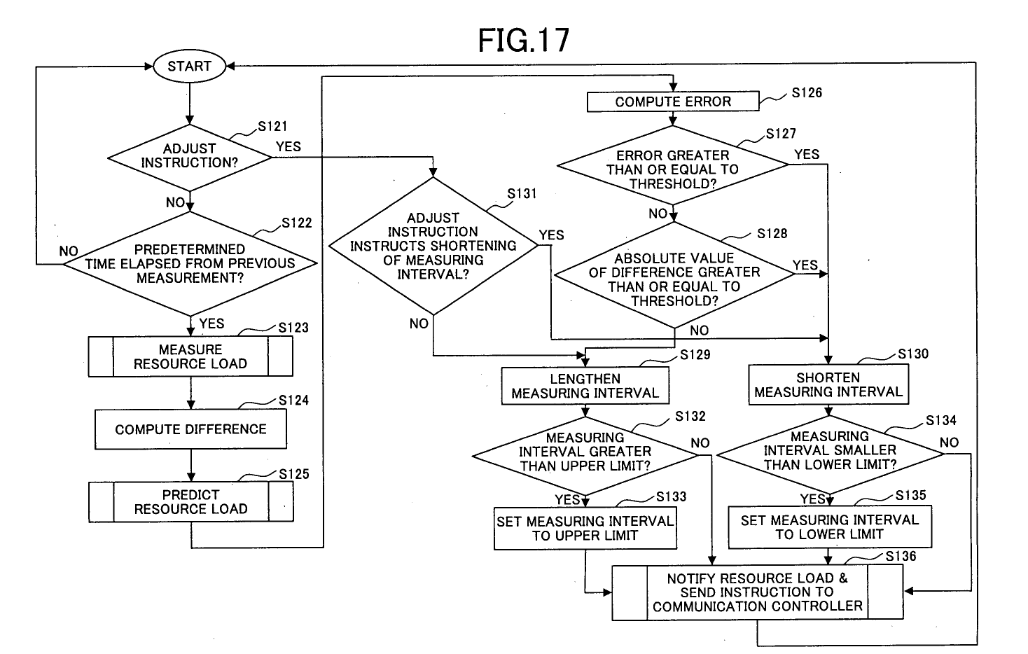

FIG. 17 is a flow chart for explaining an operation of the measuring interval controller 233 of the communication node 212 shown in FIG. 14. For the sake of convenience, FIG. 17 shows the operation of the measuring interval controller 233 for a case where the measuring interval with respect to the selected resource within the communication node 212 is adjusted.

In FIG. 17, a step S121 decides whether or not an adjust instruction is received from the communication controller 237. If the decision result in the step S121 is NO, a step S122 decides whether or not a predetermined time which is greater than or equal to the measuring interval has elapsed from the previous measurement. The process returns to the step S121 if the decision result in the step S122 is NO.

On the other hand, if a time greater than or equal to the present measuring interval elapses from the previous measuring time and the decision result in the step S122 is YES, a step S123 measures the load information of the selected resource by instructing the resource measuring section 231 by issuing the resource measure instruction. A step S124 computes a difference between the present measured load information and the previous measured load information, and stores this difference in the database 230.

A step S125 predicts the load information (predicted value) of the selected resource by instructing the resource predicting section 232 by issuing the resource predict information, and a step S126 computes the error between the measured load information (measured value) and the predicted load information (predicted value). Hence, the step S125 computes and stores the predicted value in the database 230, and the step S126 computes and stores the error in the database 30.

A step S127 decides whether or not an absolute value of the error is greater than or equal to a threshold value. If the decision result of the step S127 is NO, a step S128 decides whether or not an absolute value of the difference is greater than or equal to a threshold value.

If the decision result in the step S121 is YES, a step S131 decides whether or not the adjust instruction from the communication controller 237 instructs shortening the measuring interval. If the decision result in one of the steps S127, S128 and 131 is YES, the process advances to a step S130. On the other hand, if the decision result in the step S128 or S131 is NO, the process advances to a step S129. The step S129 starts a process of lengthening the measuring interval, and the step S130 starts a process of shortening the measuring interval.

After the step S129, a step S132 decides whether or not the measuring interval is longer than an upper limit value. If the decision result in the step S132 is YES, a step S133 sets the next measuring interval to the upper limit value. After the step S130, a step S134 decides whether or not the measuring interval is shorter than a lower limit value. If the decision result in the step S134 is YES, a step S135 sets the next measuring interval to the lower limit value. If the decision result in the step S132 or S134 is NO or, after the step S133 or S135, a step S136 notifies the resource load information to the communication controller 237, and sends a send instruction to the communication controller 237 to send the resource load information to the network control apparatus 112.

The steps S122 through S135 of the measuring interval controller 233 shown in FIG. 17 are basically the same as the steps S22 through S35 of the measuring interval controller 33 shown in FIG. 5, with the exception of the step S131 which decides whether or not the adjust instruction received from the communication controller 237 instructs shortening the measuring interval.

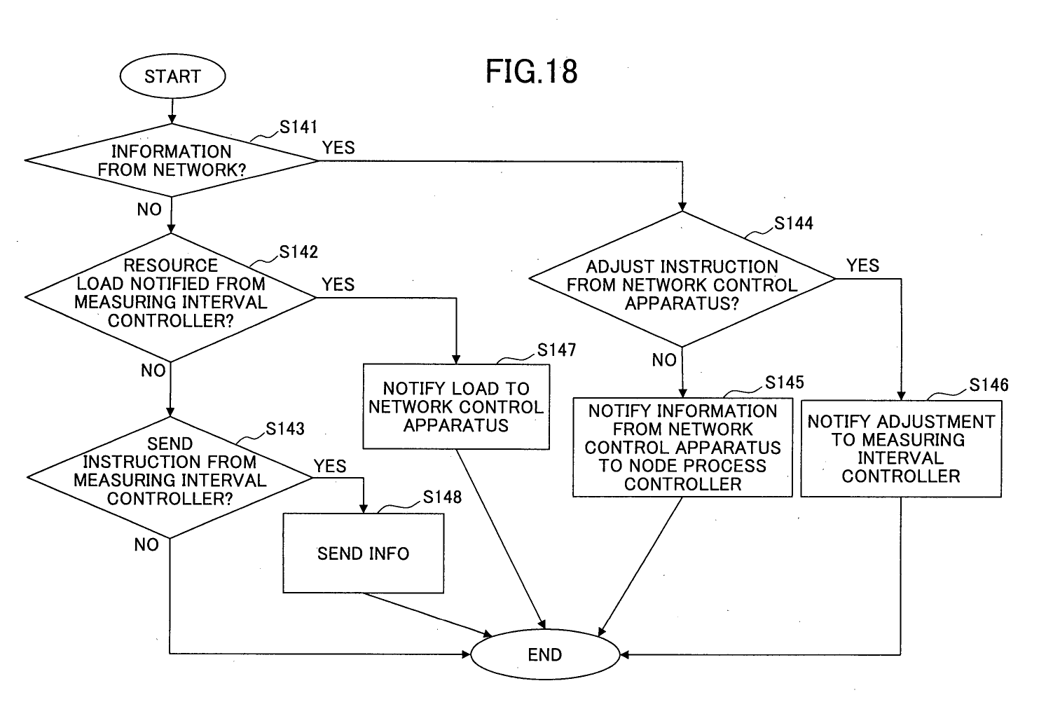

FIG. 18 is a flow chart for explaining an operation of the communication controller 237. The communication controller 237 connects to the network 11 and communicates with external equipments via the network 11, including the network control apparatus 112.

As shown in FIG. 18, a step S141 decides whether or not information is received via the network 11. If the decision result in the step S141, is NO, a step S142 decides whether or not the resource load information is notified from the measuring interval controller 233. If the decision result in the step S142 is NO, a step S143 decides whether or not the send instruction is received from the measuring interval controller 233. The process ends if the decision result in the step S143 is NO.

On the other hand, if the decision result in the step S141 is YES, a step S144 decides whether or not an adjust instruction instructing adjustment of the measuring interval is received from the network control apparatus 112. If the decision result in the step S144 is NO, a step S145 notifies the information received from the network control apparatus 112 to the node process controller 238, and the process ends. If the decision result in the step S144 is YES, a step S146 notifies the instructed adjustment of the measuring interval to the measuring interval controller 233, and the process ends.

If the decision result in the step S142 is YES, a step S147 notifies the load information stored in the database 230 to the network control apparatus 112, and the process ends. For example, the load information may be notified to the network control apparatus 112 using a trap message of the SNMP.

If the decision result in the step S143 is YES, a step S148 carries out an information transmitting process such as sending the data packets, and the process ends.

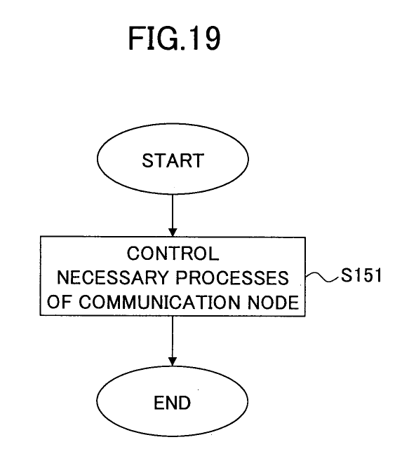

FIG. 19 is a flow chart for explaining the node process controller 238. The node process controller controls various processes of the communication node 212, based on instructions or the like from the communication controller 237.

As shown in FIG. 19, a step S151 controls the necessary processes of the communication node 212, such as a packet transfer process in the case of the router 14, based on the instruction or the like from the communication controller 237, and the process ends.

In the embodiment described above, the operation of the measuring interval controller 233 shown in FIG. 14 is carried out for each selected resource. In other words, the adjusting interval is adjusted independently for each resource within the communication node 212. However, if short adjusting intervals are set with respect to a large number of resources, the load of the resource measuring section 231 becomes high when operation of the communication node 212 is considered as a whole.

In order to avoid the load of the resource measuring section 231 from becoming too high and considerably increasing the load of the communication node 212 as a whole, the communication node 212 may carry out a process of adjusting the measuring interval by taking into consideration the load of the communication node 212 as a whole. Hence, in a modification of this embodiment, the measuring interval controller 233 may periodically adjust the measuring interval, for example, depending on the load of the communication node 212 as a whole, similarly as in the case of the network control apparatus 12 shown in FIG. 2 as described above in conjunction with FIG. 12.

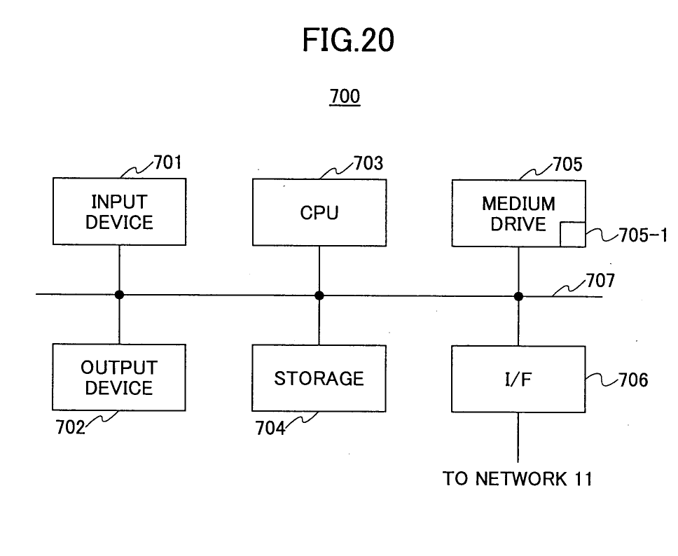

FIG. 20 is a system block diagram showing a structure of a computer which is usable as the network control apparatus and the communication node. A computer (or computer system) 700 includes an input device 701, an output device 702, a CPU 703, a storage 704, a medium drive 705 for a recording medium 705-1, and an interface (I/F) 706 which are connected via a bus 707. Of course, the input device 701 and the output device 702 may be connected directly to the CPU 703 instead of via the bus 707.

The input device 701 is formed by a keyboard, a mouse or the like and is used by the operator to input various instructions and data to the computer 700. The output device 702 is formed by a display unit, for example, to display various information such as messages. The CPU 703 controls the general operation of the computer 700. The storage 704 stores programs to be executed by the CPU 703, and data including intermediate data obtained during program execution by the CPU 703. The medium drum 705 is designed to at least read information from the recording medium 705-1, and is preferably designed to also write information on the recording medium 705-1. The recording medium 705 may be selected from any kind of media capable of storing programs and data. For example, the recording medium 705-1 is selected from magnetic recording media such as magnetic disks, optical recording media such as optical disk, and magneto-optical recording media such as magneto-optical disks. The interface 706 connects the computer 700 to the network 11. The basic structure itself of the computer 700 is known, and any other suitable basic structures may be employed for the computer 700.

An embodiment of a computer-readable storage medium according to the present invention is formed by the recording medium 705-1 which stores a computer program for causing the CPU 703 of the computer 700 to carry out the resource load measuring process described above, that is, a computer program for causing the computer 700 to function as the network control apparatus 12 or 112 or, the communication node 212. The computer program stored in the recording medium 705-1 is read by the medium drive 705 and installed in the storage 704. Of course, the computer program may be downloaded from another computer (not shown) via the network 11 and installed in the storage 704 via the interface 706.

Further, the present invention is not limited to these embodiments, but various variations and modifications may be made without departing from the scope of the present invention.

1. A resource load measuring method for measuring load information of resources within a network, comprising:
measuring the load information of the resources at measuring intervals and storing measured load information in a storage section;
predicting load information of the resources according to a prediction algorithm and storing predicted load information in the storage section; and
adjusting the measuring intervals based on the measured load information and the predicted load information stored in the storage section.

2. The resource load measuring method as claimed in claim 1, wherein the predicted load information is predicted based on time-varying information in the measured load information.

3. The resource load measuring method as claimed in claim 1, wherein the predicted load information is predicted based on at least one error between present measured load information and previous measured load information.

4. The resource load measuring method as claimed in claim 1, wherein the measuring intervals are adjusted based on at least one error between the measured load information and the predicted load information.

5. The resource load measuring method as claimed in claim 1, wherein the measuring, the predicting and the adjusting are carried out by a network control apparatus within the network, and the resources include communication nodes within the network.

6. The resource load measuring method as claimed in claim 1, wherein the measuring, the predicting and the adjusting are carried out by a communication node within the network, in response to an instruction from a network control apparatus within the network, and the resources are provided within communication node.

7. A network control apparatus coupled within a network having resources and controlling the network, comprising:
a storage section;
a measuring section to measure load information of the resources at measuring intervals and to store measured load information in the storage section;
a predicting section to predict load information of the resources according to a prediction algorithm and to store predicted load information in the storage section; and
an adjusting section to adjust the measuring intervals based on the measured load information and the predicted load information stored in the storage section.

8. The network control apparatus as claimed in claim 7, wherein said predicting section predicts the predicted load information based on time-varying information in the measured load information.

9. The network control apparatus as claimed in claim 7, wherein said predicting section predicts the predicted load information based on at least one error between present measured load information and previous measured load information.

10. The network control apparatus as claimed in claim 7, wherein said adjusting section adjusts the measuring intervals based on at least one error between the measured load information and the predicted load information.

11. A communication node coupled within a network having a network control apparatus, comprising:
a plurality of resources;
a storage section;
a measuring section to measure load information of the resources at measuring-intervals and to store measured load information in the storage section;
a predicting section to predict load information of the resources according to a prediction algorithm and to store predicted load information in the storage section; and
an adjusting section to adjust the measuring intervals based on the measured load information and the predicted load information stored in the storage section, in response to an instruction from the network control apparatus.

12. The communication node as claimed in claim 11, wherein said predicting section predicts the predicted load information based on time-varying information in the measured load information.

13. The communication node as claimed in claim 11, wherein said predicting section predicts the predicted load information based on at least one error between present measured load information and previous measured load information.

14. The communication node as claimed in claim 11, wherein said adjusting section adjusts the measuring intervals based on at least one error between the measured load information and the predicted load information.

15. A computer-readable storage medium which stores a computer program for causing a computer to measure load information of resources within a network, said computer program comprising:
a procedure to cause the computer to measure the load information of the resources at measuring intervals and to store measured load information in a storage section;
a procedure to cause the computer to predict load information of the resources according to a prediction algorithm and to store predicted load information in the storage section; and
a procedure to cause the computer to adjust the measuring intervals based on the measured load information and the predicted load information stored in the storage section.

16. The computer-readable storage medium as claimed in claim 15, wherein the predicted load information is predicted based on time-varying information in the measured load information.

17. The computer-readable storage medium as claimed in claim 15, wherein the predicted load information is predicted based on at least one error between present measured load information and previous measured load information.

18. The computer-readable storage medium as claimed in claim 15, wherein the measuring intervals are adjusted based on at least one error between the measured load information and the predicted load information.

19. The computer-readable storage medium as claimed in claim 15, wherein the measuring, the predicting and the adjusting procedures are carried out within the computer which forms a network control apparatus within the network, and the resources include communication nodes within the network.

20. The computer-readable storage medium as claimed in claim 15, wherein the measuring, the predicting and the adjusting procedures are carried out by the computer which forms a communication node within the network, in response to an instruction from a network control apparatus within the network, and the resources are provided within communication node.
